(19) United States
(12) Patent Application Publication
(10) Pub. No.: US 2013/0182974 A1
(43) Pub. Date: Jul. 18, 2013

(54) SYSTEM AND METHOD FOR OBTAINING AND ROUTING ELECTRONIC COPIES OF DOCUMENTS

(71) Applicants: Taylor Smith, Charlotte, NC (US); Geoffrey Gelay, West Deptford, NJ (US)

(72) Inventors: Taylor Smith, Charlotte, NC (US); Geoffrey Gelay, West Deptford, NJ (US)

(73) Assignee: Honeywell International, Inc. doing business as (d.b.a.) Honeywell Scanning & Mobility, Fort Mill, SC (US)

(21) Appl. No.: 13/350,366

(22) Filed: Jan. 13, 2012

(51) Int. Cl. G06K 9/54

(52) U.S. Cl. 382/306

(57) ABSTRACT

A system and method for locating an electronic document, which includes receiving an image of decodable indicia from an EIR terminal, locating said decodable indicia within the image, decoding the decodable indicia into a decoded message which contains: an identifier for an electronic document and the location of the document. Then, receiving delivery instructions regarding the document and executing those instructions.

### FIELD OF INVENTION

The present invention provides a system and method for retrieving and delivering an electronic document as an automatic response to scanning an image of decodable indicia, such as a bar code.

### BACKGROUND OF INVENTION

For practical as well as environmental reasons, electronic documents are quickly replacing their hard copy counterparts. Even if a hard copy document is of use, an electronic copy is sometimes additionally requested for public transport. Electronic reader (EReader) sales have soared and now, lending libraries have sprung up to allow individuals with EReaders to “borrow” electronic books. Documents that individuals used to save, such bank and credit card statements, are now available online and many consumers have switched to “paperless” systems of receiving these items.

Despite the convenience of paperless statements, there are instances where hard copies of documents are useful. Just because documents are available electronically, does not mean that individuals prefer them in all situations, especially individuals whose work habits were formed in an environment where e-documents were not readily available. For example, in situations where an individual wants to make notes on a document, highlight it, or otherwise mark it up, a hard copy is preferable. During lectures, individuals distribute hand outs that coordinate with the substance of the presentation.

There are times when a paper document is not preferable, but it is the only copy readily available. For example, generally, when a user buys a new product, this product comes with a user manual. This manual is useful directly after purchase and when something goes wrong with the product. The latter time can be years after the purchase. In the meantime, the consumer saves this manual, which takes up physical storage space. The number of personal and household electronic products increases seemingly exponentially each year, but the amount of storage space in a given home remains the same. Various manufacturers have started putting electronic forms of the manuals online. However, locating the correct manual, for the correct product, the correct year, and the correct model can take quite a bit of searching.

Soft copies of documents are also advantageous for travel, while hard copies of multi-page documents are difficult to transport and/or share. At times, an individual with a hard copy of a necessary document does not have an electronic copy, means to convert the hard copy into an electronic copy. Sometimes the size of the document, or the fact that it is bound, makes converting it problematic or even impossible. In these situations, the individual will search for a soft copy of the document electronically. The success of the individual in locating the document then depends both on his or her own ability to use electronic search tools and the availability of the document electronically.

Then, even if the individual finds the document, the individual then will decide how to access and/or share the electronic copy. For example, the individual can email a copy of the document to his or her own account or to that of a third party. The individual may also desire to post a copy of the document he or she located to a repository, a document management system, and/or a web site, where this individual and/or others can access the document.

A need therefore exists for an easy way to locate a soft copy of a document quickly and to route it to a desired individual and/or destination.

### SUMMARY OF INVENTION

An object of the present invention is to utilize the scanning or capture of an image of decodable indicia (e.g., a bar code) to locate, retrieve and deliver an electronic document to a person and/or destination.

Another object of the present invention is to provide a service that generates images of decodable indicia, such as bar codes, to create mappings to electronic copies of documents.

Electronic documents include, but are not limited to, any electronically stored information, including writings, drawings, graphs, charts, photographs, sound recordings, images, and other data or data compilations, stored in any medium from which information can be obtained either directly or after translation into a reasonably usable form.

Bar codes are graphical representations of data, the most common of which are referred to as one dimensional (1D) and two dimensional (2D) bar codes. 1D bar codes are images that represents data by varying the widths and spacings of parallel lines. 2D bar codes are also images that represent data, but in addition to the parallel lines, or bars, a 2D bar codes may contain rectangles, dots, hexagons and other geometric patterns in two dimensions. A common example of a 2D bar code is a Quick Response (QR) code. QR codes consist of black modules arranged in a square pattern on a white background. The data encoded in bar codes are interpreted by optical scanners and software.

Bar codes originally were scanned by special optical scanners called bar code readers; later, scanners and interpretive software became available on devices, including desktop printers and smart phones. In fact, some of the leading manufacturers of smart phones offer bar code scanning software that can be installed on their respective smart phones.

In one embodiment of the present invention, a bar code format is placed on hard copies of a document. This bar code format includes: 1) identification information regarding the document, for example, an identifier such as a primary key, a file name, a document number; 2) the location of the document on a resource, including but not limited to a repository, a LAN, a WAN and/or the Internet; and 3) instructions regarding what to do with the document once it is obtained. The bar code is scanned using a terminal (e.g., encoded information reading (EIR) terminals configured to read bar codes and/or other types of encoded information). Once scanned, the bar code is routed to a system, such as specialized hardware and/or software, that can extract this data, identify the document, locate the document, and handle the document in accordance with the instructions in the bar code. The hardware and/or software may be internal to the EIR terminal, including by not limited to a processor executing computer code, or may be external to the EIR terminal, including but not limited a network resource, such as a web server. Document delivery includes but is not limited to, emailing the document to a designated user, and/or saving a copy of the document in a repository accessible to a designated user.

In another embodiment of the present invention the bar code format includes 1) identification information regarding the document for example, an identifier such as a primary key, a file name, a document number; 2) the location of the document on a resource, including but not limited to a repository, a LAN, a WAN and/or the Internet; and 3) a reference or pointer, such as an address, to a middleware application. When a user scans a bar code, the user is brought to this middleware application. The middleware prompts to user with options, allowing the user, for example, to download, email, and/or share the electronic copy of a file. Once the user enters the command, the document is retrieved and the command chosen by the user is executed.

Another embodiment of the present invention the bar code format includes 1) identification information regarding the document for example, an identifier such as a primary key, a file name, a document number; and 2) a reference or pointer, such as an address, to a middleware application. In this embodiment, when the bar code was initially created by the system, the system mapped the identification of the document to the location. Thus, when a user scans the bar code, the user is brought to the middleware, which can located the electronic copy based upon the identification information. The middleware prompts to user with options, allowing the user, for example, to download, email, and/or share the electronic copy of a file. Once the user enters the command, the command is executed.

Although the present invention is described in relation to scanning a bar code using an optical scanner, many other variations and modifications will become apparent to those skilled in the art. The term bar code also refers to any item and/or image containing decodable indicia, including but not limited to a 1D bar code, a 2D bar code and/or one or more optical character recognition (OCR) symbols. Additionally, scanning an item also includes using any device to capture an image of the item, including but not limited to using a camera to capture an image of the item.

### BRIEF DESCRIPTION OF DRAWINGS

FIG. 1 depicts a technical architecture of an embodiment of the present invention.

FIG. 2 depicts a technical architecture of an embodiment of the present invention.

FIG. 3 depicts an example of a format of a bar code used by an embodiment of the present invention.

FIG. 4 depicts an example of a format of a bar code used by an embodiment of the present invention.

FIG. 5 depicts an example of a format of a bar code used by an embodiment of the present invention.

FIG. 6 depicts a workflow of an aspect of an embodiment of the present invention.

FIG. 7 depicts a workflow of an aspect of an embodiment of the present invention.

FIG. 8 depicts a workflow of an aspect of an embodiment of the present invention.

FIG. 9 depicts an example of a GUI screen of an embodiment of the present invention.

FIG. 10 depicts an example of a GUI screen of an embodiment of the present invention.

FIG. 11 depicts an example of a GUI screen of an embodiment of the present invention.

FIG. 12 depicts an example of a GUI screen of an embodiment of the present invention.

FIG. 13 depicts an example of a GUI screen of an embodiment of the present invention.

FIG. 14 depicts an embodiment of a computer system in incorporating one or more aspects of the present invention.

FIG. 15 depicts an embodiment of a computer program product incorporating one or more aspects of the present invention.

### DETAILED DESCRIPTION OF THE INVENTION

The present invention provides a system and method for locating and delivering an electronic document as an automatic response to scanning an image of decodable indicia.

The present invention also provides a system for mapping the location of an electronic copy of a document with an image of decodable indicia and finding this location upon scanning this image of decodable indicia.

Even in a largely “paperless” business environment, certain hard copies of documents are referenced and/or utilized. Many times, the origins of these documents are unclear. A user who requires a soft copy of a document may not know the origin of the document. The task of locating an electronic copy can be difficult. A user may not even know where to search: an Intranet, an internal document management system, a web repository, and/or the World Wide Web. Even if the user is able to locate the document, it may not be readily apparent if the document is an exact match to the hard copy. Small changes that go undetected are sometimes business critical.

When a user looks for the electronic copy, there is a reason, i.e., the user has a plan as to what to do with the electronic copy once he locates it. A user could be looking for an electronic copy in order to email it to himself or to another person. The user could be looking for the document in order to store an electronic copy somewhere accessible to himself, for future reference, and/or to other users in a business group. Thus, after locating an electronic copy of a document, the user then sends the document to a destination, for example, the user emails the document and/or saves a copy in a repository. By taking these actions, the user makes the electronic copy more easily accessible in the future.

Conversely, an individual may wish to make an electronic copy of a document easily accessible to others. By generating a bar code that represents the location of an electronic copy of the document and labeling a hard copy with the bar code, other individuals who come into contact with this document can scan the bar code and locate the electronic copy of the document quickly and easily.

An embodiment of the present invention allows a user to map a document to a location of an electronic copy, including but not limited to a document repository or a web site. The owner of a document uses this system and/or method to generate an image of decodable indicia, such as a bar code, that is encoded with at least an identifier for an electronic document. After the image of decodable indicia has been generated, the user can place it on hard copies of his or her document. Once a document has been mapped to an electronic copy, it can be retrieved by scanning the generated image of decodable indicia.

After a document is mapped to its electronic copy, in an embodiment of the present invention, a user captures an image of decodable indicia by using, for example, an optical scanner, to scan a bar code. As aforementioned, this image or bar code is optionally located on a hard copy of a document. Once the decodable indicia is decoded, the extracted decoded message contains: 1) information identifying the document for example, an identifier such as a primary key, a file name, a document number; 2) information describing the location of an electronic copy of the document; and 3) instructions regarding what should be done with the document after it is located.

In another embodiment of the present invention, the extracted decoded message contains: 1) information identifying the document for example, an identifier such as a primary key, a file name, a document number; and 2) information describing the location of an electronic copy of the document. In this embodiment, when a user scans an image of decodable indicia, that individual is prompted with options for delivery instructions for the destination file. These delivery instructions include, but are not limited to, downloading the file, emailing the file, emailing the location only, sharing the document by posting a hyperlink to the document on a web site, for example, placing a link on the user's wall on Facebook.

In another embodiment of the present invention, the extracted decoded message contains: 1) information identifying the document, for example, an identifier such as a primary key, a file name, a document number; and 2) a command directing the scanning software to access a middleware application; and 3) the location of an electronic copy of the document once the decodable indicia is decoded. In this embodiment, when a user scans an image of decodable indicia, that individual is redirected to the middleware application which prompts the user with options for delivery instructions for the destination file. These delivery instructions include, but are not limited to, downloading the file, emailing the file, emailing the location only, sharing the document by posting a hyperlink to the document on a web site, for example, placing a link on the user's wall on Facebook.

In another embodiment of the present invention, the extracted decoded message contains: 1) information identifying the document for example, an identifier such as a primary key, a file name, a document number; and 2) a command directing the scanning software to access a middleware application. Based on the identifier, the middleware application identifies the location of the document. In this embodiment, when a user scans an image of decodable indicia, that individual is redirected to the middleware application which prompts the user with options for delivery instructions for the destination file. These delivery instructions include, but are not limited to, downloading the file, emailing the file, emailing the location only, sharing the document by posting a hyperlink to the document on a web site, for example, placing a link on the user's wall on Facebook.

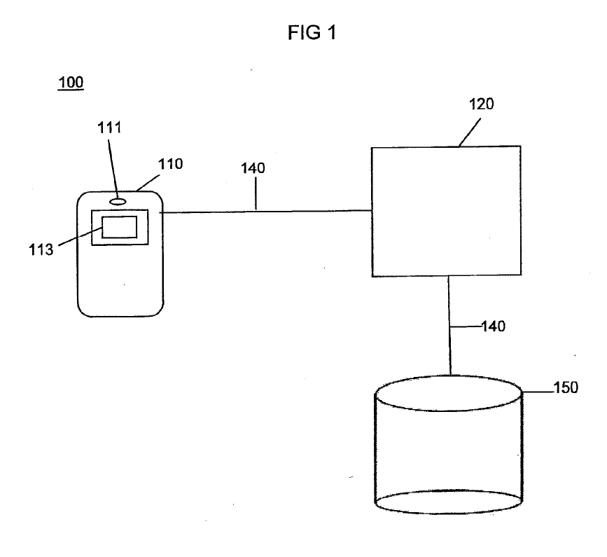

Referring to FIG. 1, the technical architecture 100 of one embodiment of the present invention comprises: 1) a terminal (e.g., encoded information reading (EIR) terminals configured to read bar codes and/or other types of encoded information) that is configured to capture and/or scan images containing decodable indicia, such as bar codes 110; 2) a computer 120; 3) a communications network 140; and 4) an electronic document repository 150.

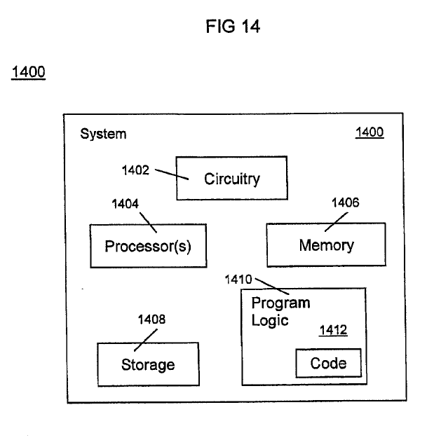

In an embodiment of the present invention, both computer 120 and EIR terminal 110 are computer systems 110, 210, 120, 220 as described in FIG. 14.

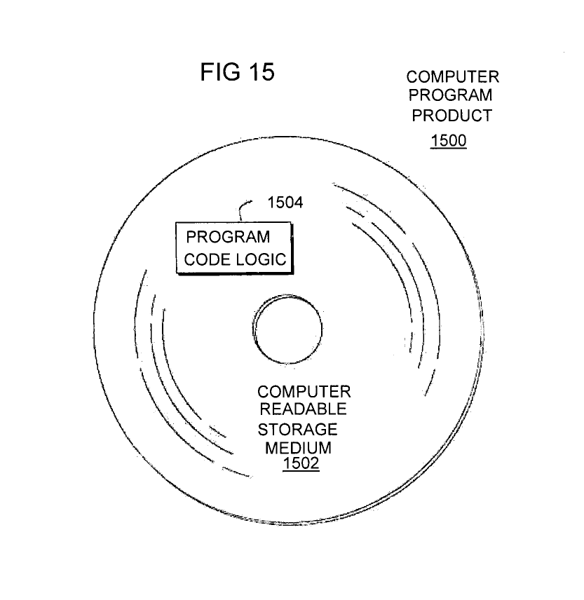

The EIR terminal 110 has the capability to receive data that is entered into the graphical user interface (GUI) 113 on the EIR terminal 110 by a user. The user enters data into the GUI 113 on the EIR terminal 110, which the EIR terminal 110 sends to the computer 120 via the communication network 140. Program code, which can be located on the computer 112 or on a remote resource, as described in FIG. 15, executes on computer 120 and generates an image containing decodable indicia. The decodable indicia is the encoded information entered by the user, or data representative of this information that program code can later map back to the information entered by the user. The information includes, but is not limited to, an identifier for a document.

In an embodiment of the invention, the encoded data includes the location of an electronic copy of the document and instructions regarding the delivery of the document once it is located. In another embodiment of the current invention, the encoded data includes a pointer to middleware, that is executed on computer 120, that prompts the user to enter delivery instructions for the document.

In one embodiment of the present invention, instructions to access a middleware application are encoded into the image of decodable indicia. This middleware application accepts input from the user regarding the delivery and/or delivery instructions for the electronic copy of the document.

The EIR terminal 110 has the capability to scan and/or capture an image containing decodable indicia. In this embodiment, the EIR terminal 110 has a camera 111 to capture a bar code. The camera 111 captures the image of decodable indicia representative of a document and sends the image via the communication network 140 to the computer 120. The image of decodable indicia can be provided by a raw image byte stream, a compressed image byte stream, and/or a partial compressed image byte stream.

Although this embodiment utilizes a camera to capture the image of decodable indicia, one of ordinary skill in the art will recognize that the image of decodable indicia can be scanned and/or read with optical scanning devices as well.

By scanning or capturing the image of decodable indicia with the EIR terminal 110, the user is utilizing this invention to find an electronic copy of the document referenced in the image of decodable indicia.

The computer 120 receives the image and software executing on one or more processors on this computer 120 locates the decodable indicia within said image and decodes the bar code into a decoded message containing: 1) the identity of a document, for example, an identifier such as a primary key, a file name, a document number; 2) the location of an electronic copy of this document; and 3) instructions specifying what to do with this document after it is located. If necessary, the code interprets the identifier.

Program code executing on one or more processors on computer 120 queries the specified location, for example, document repository 150, for the requested document. The requested document is retrieved from document repository 150 and routed by computer 120, according to the instructions encoded in the image. For example, if the instructions specify that an electronic copy of the document should be emailed to the user of the EIR terminal, software on computer 120, such as an email program, emails the electronic document over the communications network 140 to that user at his email address.

In another embodiment of the present invention, the decoded message contains: 1) the identity of a document, for example, an identifier such as a primary key, a file name, a document number; 2) the location of an electronic copy of this document; and 3) a pointer to middleware that will accept and execute commands regarding the delivery of the located electronic copy. In the embodiment of FIG. 1, the middleware program code is executed on one or more processors of computer 120.

In this embodiment, the image of decodable indicia is scanned and/or captured by the EIR terminal 110. Then, this image is sent to and received by the computer 120. The image of decodable indicia can be provided by a raw image byte stream, a compressed image byte stream, and/or a partial compressed image byte stream. The image of decodable indicia is decoded by computer 120.

The middleware executing on the computer 120 interprets the identifier, if necessary, and prompts the user for delivery instructions regarding the electronic document. The program code executing on one or more processors on computer 120 locates and/or retrieves the document from document repository 150 for delivery in accordance with the delivery instructions entered. These delivery instructions include, but are not limited to, downloading the file, emailing the file, emailing the location only, sharing the document by posting a hyperlink to the document on a web site, for example, placing a link on the user's wall on Facebook. The delivery options are displayed to the user on the EIR terminal 110, in a graphical user interface (GUI) 113. The computer 120, by way of the EIR terminal 110 and the communications network 140, receives the instructions entered in the GUI and executes these instructions.

In one embodiment of the present invention, when program code executing on computer 120 generates the image of decodable indicia, it stores all or a portion of information entered by the user in the GUI 113 of the EIR terminal 110 on a storage resource of computer 120 in a non-volatile memory.

The information encoded in the image is a pointer to the information entered, and now stored, and a reference to a middleware program executing on computer 120, which accesses the mapping. For example, the image of decodable indicia could be encoded with: 1) the primary key 311; and 2) a URL that directs to the user interface of the middleware. When this image is scanned, the GUI 113 accesses the middleware at the URL provided. The middleware interprets the primary key 311 as referring to information entered by a user about a document called, for example, Document.doc, and its location, for example, at http://www.documents.com/document,doc. From the stored information, the middleware can retrieve the electronic copy of the document and/or the delivery instructions.

FIG. 1 has single document repository 150 on the communications network 140. One of skill in the art will appreciate that any number or type of document sources can be used in conjunction with this and other embodiments of the present invention to house requested documents.

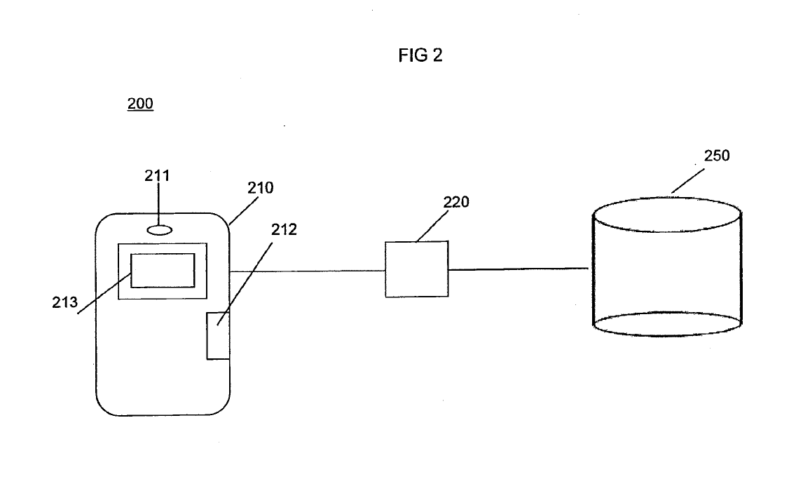

FIG. 2 depicts the technical architecture 200 of another embodiment of the present invention. In this embodiment, the EIR terminal 210 performs the computational functions performed by the computer 120 in the embodiment of FIG. 1. The EIR terminal 210 in this embodiment has the capability to scan and/or capture an image containing decodable indicia. Additionally, the document repository 250 is not located on the same internal network as the EIR terminal 210 and is accessed via a gateway 220.

In this embodiment, the EIR terminal 210 has a camera 211 to capture an image containing decodable indicia, here, a bar code. The camera 211 captures an image of a bar code. In another embodiment of the present invention, instead of a camera 211, the an EIR terminal is equipped with an optical scanner.

Software running on the EIR terminal's 210 internal processor 212 locates the decodable indicia within the image and decodes the bar code into a decoded message containing: 1) the identity of the document, for example, an identifier such as a primary key, a file name, a document number; 2) location of an electronic copy of the document; and 3) instructions specifying what to do with the document after it is located.

The EIR terminal 210 sends the decoded message to a gateway 220. This gateway 220 includes but is not limited to a proxy server, a web server, a router, and/or a network gateway. The gateway 220 routes the decoded message to the document repository 250, from which the requested electronic document is retrieved and viewable through a graphical user interface (GUI) 213 on the EIR terminal 210, including but not limited to a Web Browser.

The document repository 250 beyond the gateway 220 includes, but is not limited to, a document management system on a separate network or on the Internet, a website, a combination of websites, and even an online document repository, such as a SharePoint site.

Following the instructions in the decoded message, the internal processor 212 of the EIR terminal 210 routes the document to the designated location. The instructions include, but are not limited to, specifying that the electronic document should be emailed to a user, saving the document to the internal storage on the EIR terminal 210, and/or saving the electronic copy in a document repository 260 on the internal network.

In another embodiment, utilizing the technical architecture of FIG. 2, internal processor 212 locates the decodable indicia within the image and decodes the bar code into a decoded message containing: 1) the identity of the document for example, an identifier such as a primary key, a file name, a document number; 2) location of an electronic copy of the document; and 3) a call to a middleware application.

The middleware application interprets the identifier, if necessary, and prompts for and receives information regarding the delivery instructions of the electronic document, once it is located. These delivery instructions include, but are not limited to, downloading the file, emailing the file, emailing the location only, sharing the document by posting a hyperlink to the document on a web site, for example, placing a link on the user's wall on Facebook.

Utilizing the technical architecture of FIG. 2, the middleware application executes on the internal processor 212 of the EIR terminal 210, on the web server associated with the gateway 220, or on both. The storage location of the code includes but is not limited to the internal processor 212, the server associated with the gateway 220, both, or another computer or detachable storage medium (not pictured).

The user enters delivery instructions in the GUI 213 of the EIR terminal 210, which are received by the middleware application. The middleware application executes the delivery instructions after or while retrieving the electronic copy of the document identified in the image of decodable indicia from the location specified in the image of decodable indicia, in this embodiment, the document repository 250.

The embodiments of FIG. 1 and FIG. 2 are meant as examples of how the method of the present invention can be distributed differently in two varying technical configurations. One of skill in the art will appreciate that the processing tasks, which include but are not limited to encoding data and creating a bar code, capturing a bar code, decoding a bar code, locating an identified document, and routing this identified document to a specified location and/or user, can be divided, sub-divided, or performed by a single system resource in accordance with the resources available, and the perceived advantages and/or disadvantages of various technical configurations. For example, depending upon the technical architecture of the embodiment, a component configured to output an image of decodable indicia include but is not limited to: 1) an EIR terminal outputting the an image of decodable indicia for decoding to a processor internal to the EIR terminal, 2) an EIR terminal outputting the an image of decodable indicia for decoding to a processor external to the EIR terminal, 3) an optical scanner outputting an image of decodable indicia for decoding to a processor internal to the same client as the optical scanner, 4) an optical scanner outputting an image of decodable indicia for decoding to a processor external to the client that comprises the optical scanner, 5) an image capture device, such as a camera, outputting an image of decodable indicia for decoding to a processor internal to the same client as the image capture device, and 6) an image capture device, such as a camera, outputting an image of decodable indicia for decoding to a processor external to the client that comprises the image capture device.

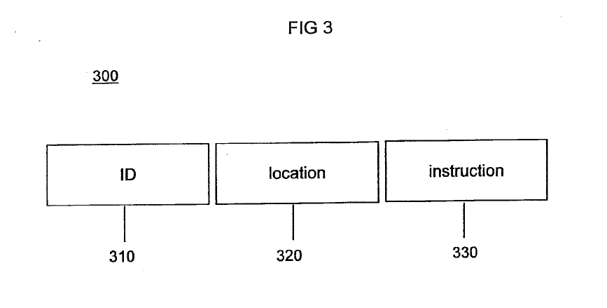

FIG. 3 depicts an exemplary format 300 of the data in an image with decodable indicia, such as a bar code, utilized by an embodiment of the present invention. Referring to FIG. 3, the format is broken up into three sections. The first section 310, identifies the document, for example, using an identifier. The second section 320, contains the location of the document. If this document is retrievable from a web site, the location information format includes, but is not limited to, a URL. The third section 330, contains delivery instructions, i.e., where to email the document or where to save it once located.

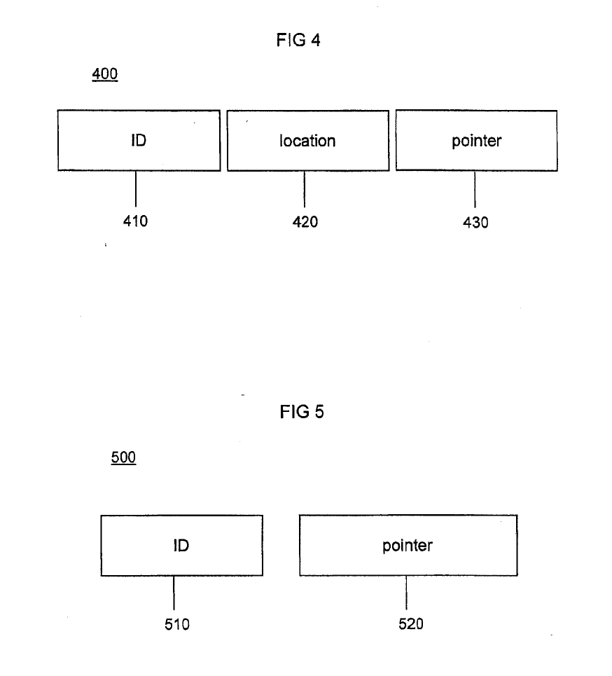

FIG. 4 depicts an exemplary format 400 of the data in an image of decodable indicia, such as a bar code, utilized by an embodiment of the present invention. Referring to FIG. 4, the format is broken up into three sections. The first section 410, identifies the document, for example, using an identifier. The second section 420, contains the location of the document. If this document is retrievable from a web site, the location information format includes, but is not limited to, a URL. The third section 430, contains a call to middleware that will receive and execute the delivery instructions. This call can include the URL of a web site where the middleware is accessible.

FIG. 5 depicts an exemplary format 500 of the data in an image with decodable indicia, such as a bar code, utilized by an embodiment of the present invention. Referring to FIG. 5, the format is broken up into two sections. The first section 510, identifies the document, for example, using an identifier. The second section 520, contains a call to middleware that will receive and execute the delivery instructions. This call can include the URL of a web site where the middleware is accessible. In this embodiment, the location of the document is stored on a storage resource accessible to the computer executing the program code of the middleware. Using the identifying information in the bar code, the middleware can retrieve the location information from the storage resource.

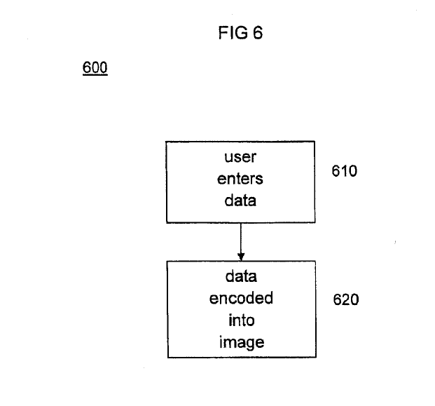

FIG. 6 is a workflow 600 of generating an image of decodable indicia, such as a bar code, in an embodiment of the present invention. In this workflow 600, the computer system, such as computer 120, internal processor 212, and/or gateway 220 receives information regarding the document and executes code to generate an image of decodable indicia that can be used to locate and route the electronic copy.

Referring to FIG. 6, the user of the EIR terminal 110, 210, enters information into the GUI 113, 213 describing at least the location of an electronic document (S610). The system then generates an image of decodable indicia that contains some of the received information and/or a primary key that the application can later use to link the document with the information originally entered (S620).

The received information includes, but is not limited to, information identifying the document and/or the location of the electronic copy of the document. The received information optionally includes full or partial delivery instructions for electronic copies of the documents.

After the image of decodable indicia is generated, it becomes a link to the electronic copy of the document with which it is associated. Depending upon the type of information in the image of decodable indicia, the location and retrieval and delivery of the electronic copy of the document will vary. For example, when the image of decodable indicia contains identification information, the document location, and complete delivery instructions (e.g., instructions to email the document to a working email address), the retrieval and delivery of the document can be accomplished without receiving additional instructions.

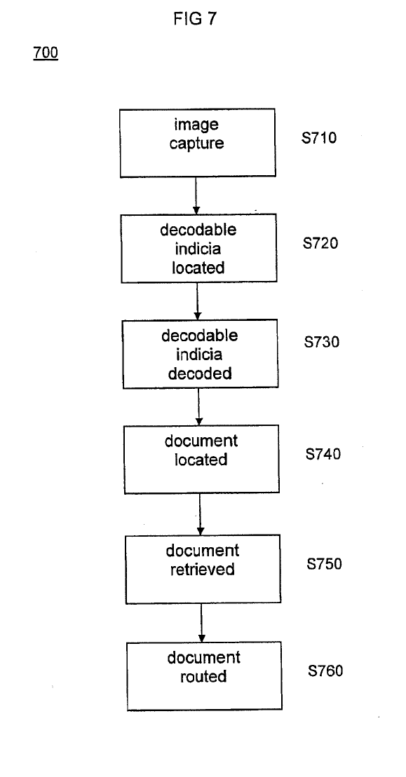

Referring to FIG. 7, workflow 700, the image containing decodable indicia, is scanned (or captured in some manner) by an EIR terminal (S710). The terminal sends a decoding request to the software responsible for decoding the image of decodable indicia. After the bar code is scanned, the decodable indicia is located (S720) and this decodable indicia is decoded, resulting in a decoded message (S730). Using the information in the decodable message, i.e., the identifier, location, and delivery instructions, the electronic document is located (S740) and retrieved (S750). The retrieved document is then routed in accordance with the decoded message instructions (S760). In some instances, the document is emailed and in others, it is saved in an alternate location, for example, to a storage resource local to the EIR terminal 110, 210.

Rather than store the routing information for an electronic copy in a bar code or other image with decodable indicia, this image of decodable indicia can optionally contain only identification information and location information. In an embodiment of the present invention, when this type of bar code is scanned, the user of the EIR terminal is prompted to enter instructions regarding the delivery of the electronic copy. Those skilled in the art will appreciate that the prompt and the instructions can occur in different formats, for example, a user can enter instructions in a GUI on the EIR terminal, and/or can be prompted via a voice prompt and use his voice to respond with instructions.

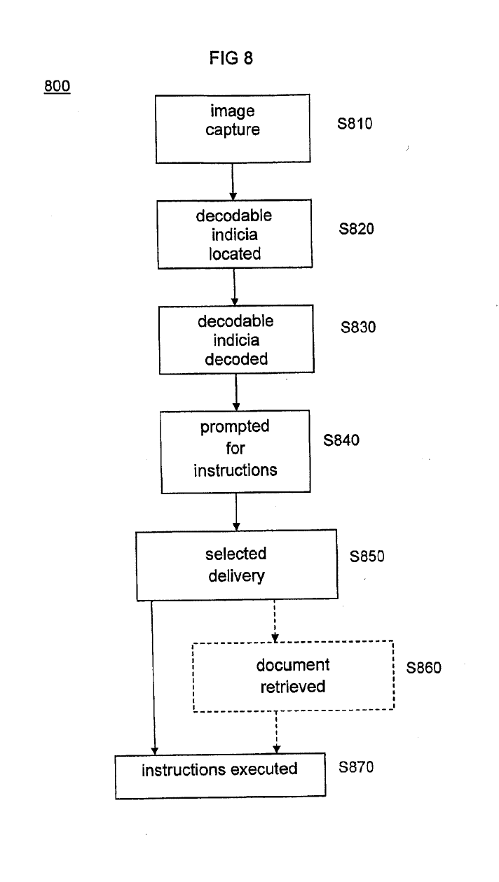

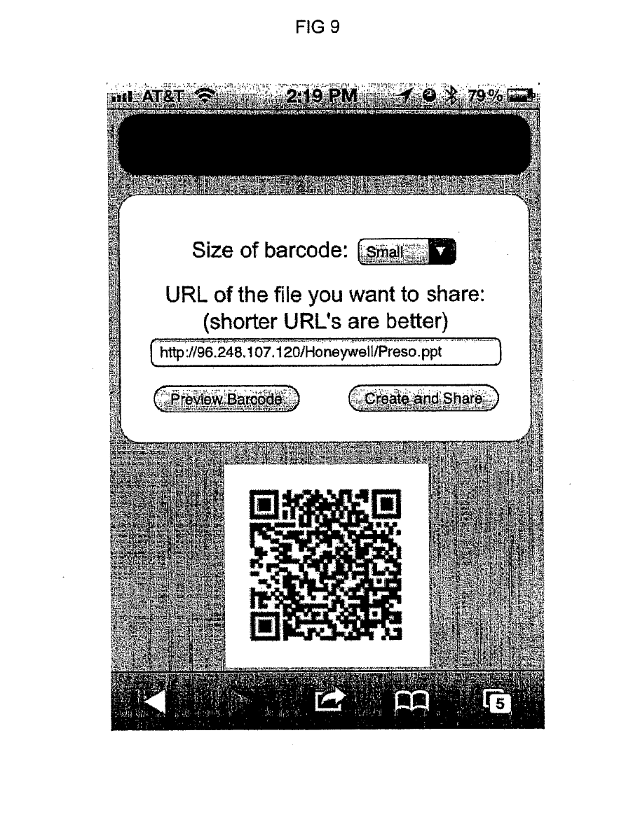

Referring to FIG. 8, a workflow 800 of another embodiment of the present invention begins when an a bar code, or any image containing decodable indicia, is scanned (or captured in some manner) by an EIR terminal (S810). The terminal sends a decoding request to the software responsible for decoding the image of decodable indicia. After the bar code is scanned, the decodable indicia is located (S820) and this decodable indicia is decoded resulting in a decoded message (S830). In this embodiment, the decoded message includes, but is not limited to, an identifier for a document and location information identifying the location of the document. Because there are no delivery instructions, the user is then prompted to enter delivery instructions (S840), which include but are not limited to downloading the document to the user's EIR terminal 110, 210. The user selects a delivery instruction (S850). In response to receiving the delivery instruction, if needed, the application retrieves the specified document from the specified location (S860) and executes the delivery instructions (S870). Some instructions, such as emailing a link to the electronic document to an email address, do not require downloading the document.

In some instances, the image of decodable indicia may contain incomplete information about the routing of the identified electronic document. In this case, in an embodiment of the present invention, the user is prompted to enter additional instructions. For example, an image of decodable indicia may contain instructions to email the identified document. However, no destination email may be either specified or decipherable from the image of decodable indicia. In this situation, the system prompts the user to enter a destination email address.

Rather than encode the information entered by a user directly into the image of decodable indicia, an embodiment of the present invention can encode a pointer to a middleware application that handles the electronic document in accordance with the instructions (e.g., emails the document and/or saves the document to a specified location) and an identifier for the document. In this embodiment, the information in the image of decodable indicia is: 1) the identifier for the document which is a unique identifier within the middleware layer; and 2) a reference and/or call to the middleware application running on the processor 212 of the EIR terminal 210, the computer 120, and/or a server resource associated with the gateway 220.

FIGS. 9-13 are exemplary illustrations, screenshots, of the GUI 113, 213 viewable on the EIR terminal during the workflow of some embodiments of the present invention. The illustrations are of the front end of the middleware application executing on a computer system, such as computer 120, a resource of gateway 220, and/or internal processor 212. When there are no instructions in the image of decodable indicia, the user interface in the middleware receives delivery instructions.

FIG. 9 is a screenshot of a screen of the application that accepts information about the document and its location, and generates the image of decodable indicia, in this example a QR Code. In this example, the user of the EIR terminal 110, 210, indicates a size preference for the image of decodable indicia, and enters a URL, representing the location of the electronic copy. The URL includes the file name, identifier, for the file. The user selects options to preview the bar code and/or share the bar code (i.e., email it to a destination or post it on a web site, including a social networking web site, such as Facebook).

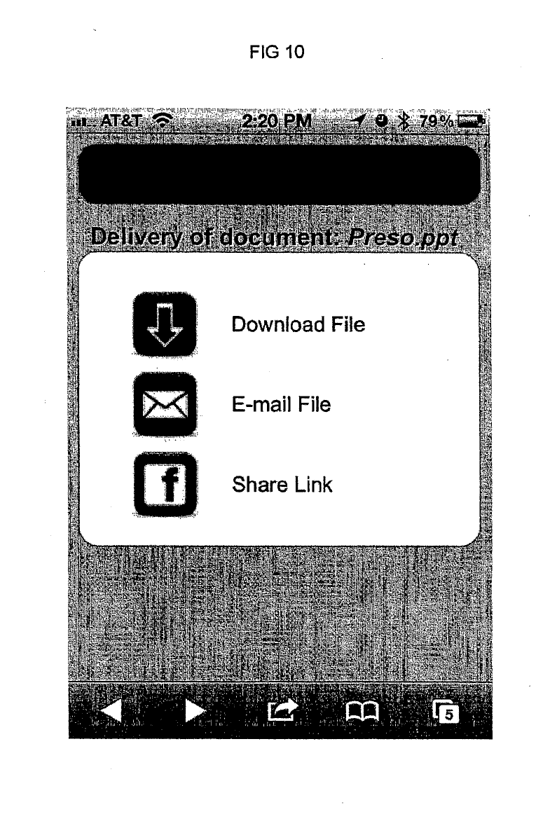

When a user scans the QR Code generated in FIG. 9, the screen of FIG. 10 appears on the EIR terminal 110, 210 used to scan the code. The decoding software locates the decodable indicia in the QR Code and decodes the QR Code, directing the browser on the device, GUI 113, 213, to access a web address. This web page is the front end to a middleware application that accepts delivery instructions. Also in the decoded message, is the file identification and location, i.e., the URL in FIG. 9.

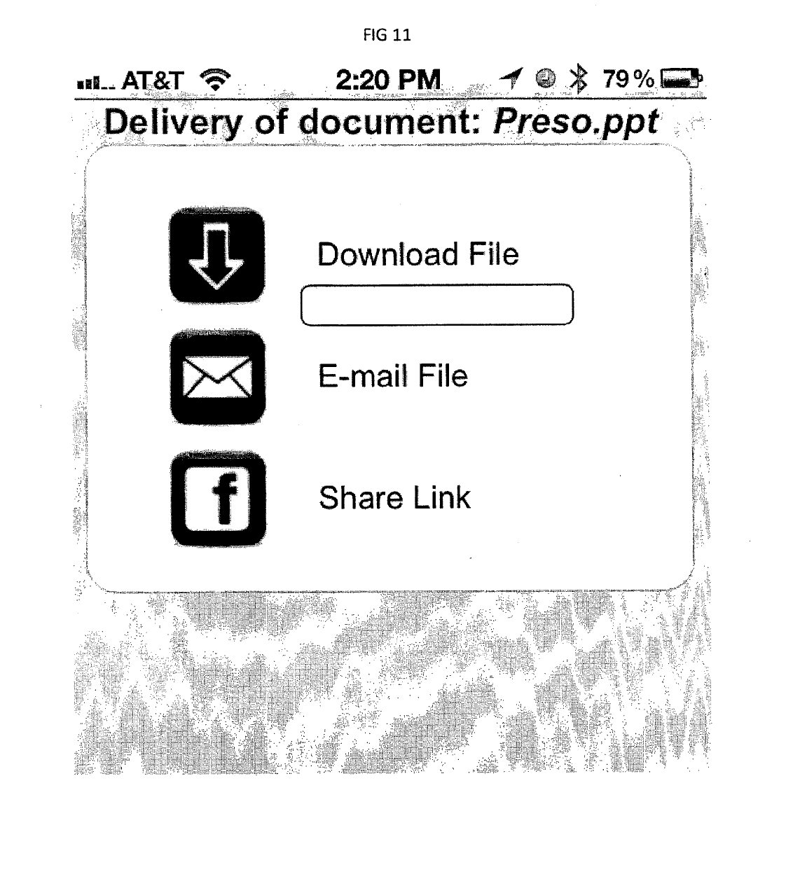

In the embodiment of FIG. 10, the user can enter delivery instructions. The user can select an option to download the identified file (i.e., Preso.ppt) from the identified location (http://96.248.107.120/Honeywell/Preso.ppt) to a storage resource, including but not limited to, the internal memory of the EIR terminal 110, 210. The user can select an option to email the file. The user can select an option to share the file via a link on Facebook. In FIG. 11, the user has selected the option to download the electronic document file.

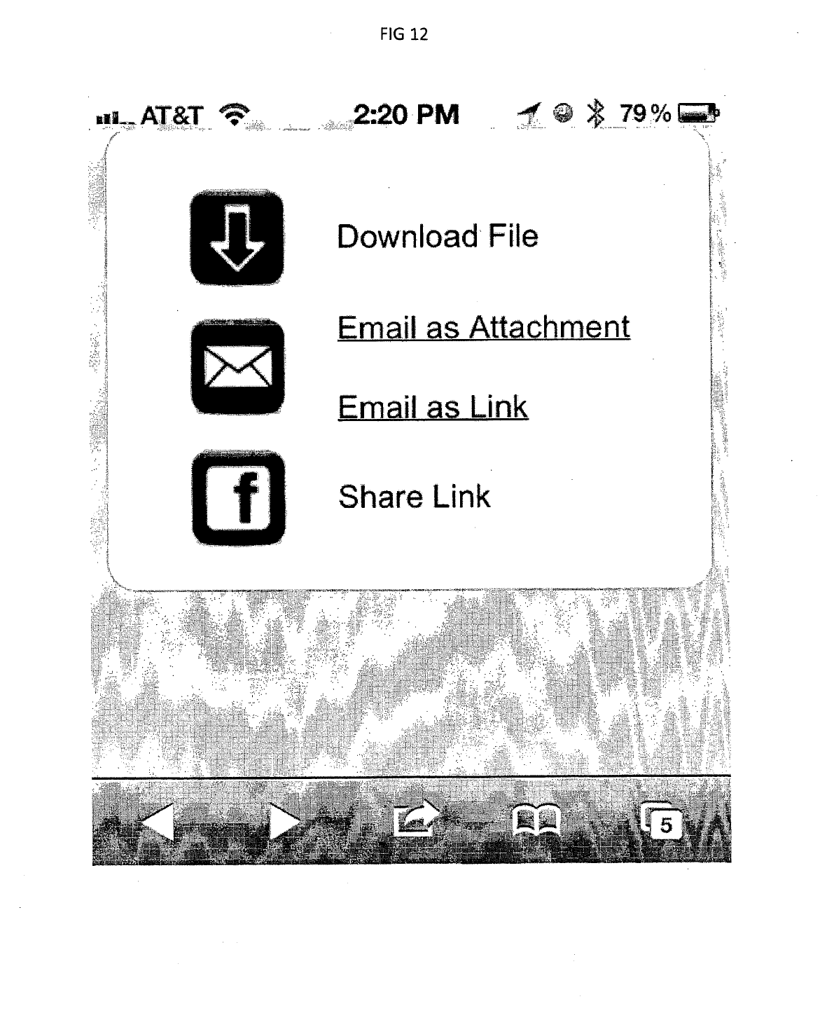

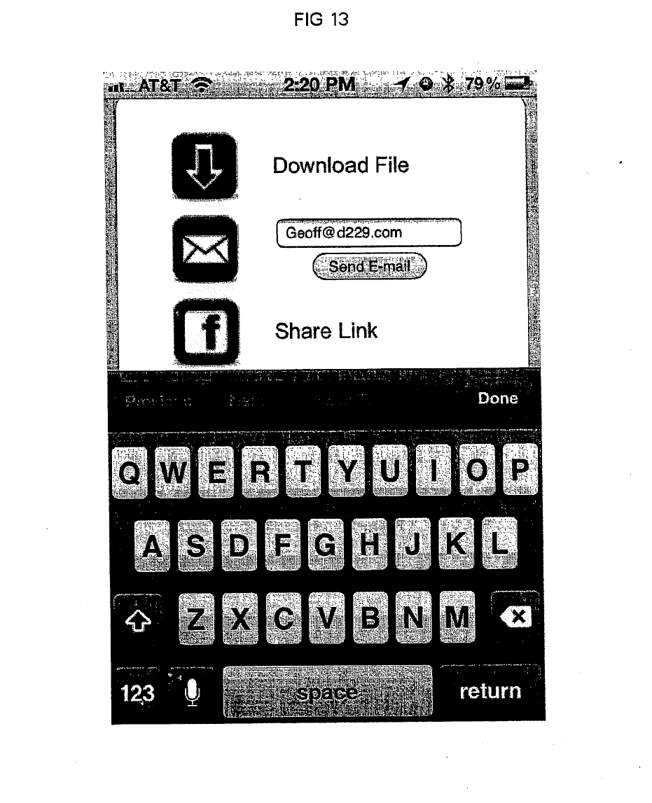

After selecting the option to email the file in FIG. 12, the user can select options to email the file as an attachment, or email a link to the file, in this case, http://96.248.107.120/Honeywell/Preso.ppt. In FIG. 13, the front end interface enables the user to enter the destination email address after selecting the attachment or link delivery option.

In an embodiment of the present invention, security on various documents can prevent the delivery specified by the instructions in the image and/or those entered by the user. For example, if the document is for internal use only, an instruction to email it to an email address outside of a company's domain could trigger an error. In this case, a user can be prompted for alternate instructions. Securing the documents within this embodiment includes but is not limited to the following approaches: encoding security limitations into the image with decodable indicia, integrating security limitations into the software that receives the requests and/or retrieves the documents, and/or integrating the security limitations into the repository.

The embodiments of FIGS. 1 and 9 contain an EIR terminals 110, 210, a computer 120, and a gateway 220. These enumerated resources are all individually computer systems 1400, as illustrated in FIG. 14.

FIG. 14 illustrates a block diagram of a computer system 1400 which is part of the technical architecture of certain embodiments of the present invention. The system 1400 may include a circuitry 1402 that may in certain embodiments include a microprocessor 1404. The computer system 1400 may also include a memory 1406 (e.g., a volatile memory device), and storage 1408. The storage 1408 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 1408 may comprise an internal storage device, an attached storage device and/or a network accessible storage device. The system 1400 may include a program logic 1410 including code 1412 that may be loaded into the memory 1406 and executed by the microprocessor 1404 or circuitry 1402.

In certain embodiments, the program logic 1410 including code 1412 may be stored in the storage 1408. In certain other embodiments, the program logic 1410 may be implemented in the circuitry 1402. Therefore, while FIG. 14 shows the program logic 1410 separately from the other elements, the program logic 1410 may be implemented in the memory 1406 and/or the circuitry 1402.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable signal medium may include a propagated data signal with computer readable program code embodied therein, for example, in baseband or as part of a carrier wave. Such a propagated signal may take any of a variety of forms, including, but not limited to, electro-magnetic, optical or any suitable combination thereof. A computer readable signal medium may be any computer readable medium that is not a computer readable storage medium and that can communicate, propagate, or transport a program for use by or in connection with an instruction execution system, apparatus or device.

A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Computer-readable code or instructions need not reside on the enumerated computer systems 110, 120, 210, 220 in FIG. 1 and FIG. 2. Referring to FIG. 15, in one example, a computer program product 1500 includes, for instance, one or more non-transitory computer readable storage media 1502 to store computer readable program code means or logic 1504 thereon to provide and facilitate one or more aspects of the present invention.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language, such as Java, Smalltalk, C++ or the like, and conventional procedural programming languages, such as the “C” programming language, assembler or similar programming languages. The program code may execute entirely on one resource of a data processing and storage system, such as a cloud, partly on various resources, and/or partly on the EIR terminal and partly on one or more resources of the data processing and storage system.

One or more aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition to the above, one or more aspects of the present invention may be provided, offered, deployed, managed, serviced, etc. by a service provider who offers management of customer environments. For instance, the service provider can create, maintain, support, etc. computer code and/or a computer infrastructure that performs one or more aspects of the present invention for one or more customers. In return, the service provider may receive payment from the customer under a subscription and/or fee agreement, as examples. Additionally or alternatively, the service provider may receive payment from the sale of advertising content to one or more third parties.

In one aspect of the present invention, an application may be deployed for performing one or more aspects of the present invention. As one example, the deploying of an application comprises providing computer infrastructure operable to perform one or more aspects of the present invention.

As a further aspect of the present invention, a computing infrastructure may be deployed comprising integrating computer readable code into a computing system, in which the code in combination with the computing system is capable of performing one or more aspects of the present invention.

As yet a further aspect of the present invention, a process for integrating computing infrastructure comprising integrating computer readable code into a computer system may be provided. The computer system comprises a computer readable medium, in which the computer medium comprises one or more aspects of the present invention. The code in combination with the computer system is capable of performing one or more aspects of the present invention.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiment with various modifications as are suited to the particular use contemplated.

Although the present invention has been described in relation to particular embodiments thereof, many other variations and modifications will become apparent to those skilled in the art. As such, it will be readily evident to one of skill in the art based on the detailed description of the presently preferred embodiment of the system and method explained herein, that different embodiments can be realized.

1. A computer system for locating an electronic document, the computer system comprising:
one or more processors, one or more computer-readable memories and one or more computer-readable, tangible storage devices;
program instructions, stored on at least one of the one or more storage devices for execution by at least one of the one or more processors via at least one of the one or more memories, to receive a decoding request from a component configured to output said image of decodable indicia
wherein said decoding request comprises an image of decodable indicia;
program instructions, stored on at least one of the one or more storage devices for execution by at least one of the one or more processors via at least one of the one or more memories, to, responsive to receiving said image of decodable indicia from said component, locate said decodable indicia within said image;
program instructions, stored on at least one of the one or more storage devices for execution by at least one of the one or more processors via at least one of the one or more memories, to, responsive to locating said decodable indicia within said image, decode said decodable indicia into a decoded message
wherein said decoded message comprises: an identifier for an electronic document, the location of said electronic document;
program instructions, stored on at least one of the one or more storage devices for execution by at least one of the one or more processors via at least one of the one or more memories, to, responsive to decoding said image of decodable indicia, interpret said identifier to identify said electronic document;
program instructions, stored on at least one of the one or more storage devices for execution by at least one of the one or more processors via at least one of the one or more memories, to receive a delivery instruction for said electronic document; and
program instructions, stored on at least one of the one or more storage devices for execution by at least one of the one or more processors via at least one of the one or more memories, to, responsive to receiving said delivery instruction, execute said delivery instruction
wherein said delivery instruction is one or more of: emailing said electronic document to an email address, saving said document to a storage resource in non-volatile memory, creating a hyperlink to said location on a web site.

2. The computer system of claim 1, further comprising:
program instructions, stored on at least one of the one or more storage devices for execution by at least one of the one or more processors via at least one of the one or more memories, to establish a communication session with said component
wherein said communication session is supported using at least one of: HTTP cookies, dynamic URLs.

3. The computer system of claim 1, wherein said location is represented by a URL.

4. The computer system of claim 1, wherein said identifier is represented by a URL.

5. The computer system of 1, wherein said decodable indicia is provided by at least one of: a 1D bar code, a 2D bar code, and one or more OCR symbols.

6. The data decoding system of claim 1, wherein said component comprises at least one of: an encoded information reading (EIR) terminal, an optical scanner, a camera.

7. The data decoding system of claim 1, wherein said decoded message additionally comprises said delivery instruction.

8. A method for locating an electronic document, the method comprising the steps of:
a computer receiving an image of decodable indicia from a component configured to output said image of decodable indicia;
said computer, responsive to receiving said image of decodable indicia from said component, locating said decodable indicia within said image;
said computer, responsive to locating said decodable indicia within said image, decoding said decodable indicia into a decoded message
wherein said decoded message comprises: an identifier for an electronic document, the location of said electronic document;
said computer, responsive to decoding said decodable indicia into a decoded message, interpreting said identifier to identify said electronic document;
said computer receiving a delivery instruction for said electronic document;
said computer executing said delivery instruction
wherein said delivery instruction is one or more of: emailing said electronic document to an email address, saving said document to a storage resource in non-volatile memory, creating a hyperlink to said location on a web site.

9. The method of claim 8, further comprising:
said computer establishing a communication session with said component
wherein said communication session is supported using at least one of: HTTP cookies, dynamic URLs.

10. The method of claim 8, wherein said location is represented by a URL.

11. The method of claim 8, wherein said identifier is represented by a URL.

12. The method of claim 8, wherein said decodable indicia is provided by at least one of: a 1D bar code, a 2D bar code, and one or more OCR symbols.

13. The method of claim 8, wherein said component comprises at least one of: an encoded information reading (EIR) terminal, an optical scanner, a camera.

14. The method of 8, wherein said decoded message additionally comprises said delivery instruction.

15. A computer program product for locating an electronic document, the computer program product comprising:
one or more computer-readable tangible storage devices;
program instructions, stored on at least one of the one or more storage devices, to receive an image of decodable indicia from a component configured to output said image of decodable indicia;
program instructions, stored on at least one of the one or more storage devices, to, responsive to receiving said image of decodable indicia from said component, locate said decodable indicia within said image;
program instructions, stored on at least one of the one or more storage devices, to, responsive to locating said decodable indicia within said image, decode said decodable indicia into a decoded message
wherein said decoded message comprises: an identifier for an electronic document, the location of said electronic document;
program instructions, stored on at least one of the one or more storage devices to, responsive to decoding said image of decodable indicia, interpret said identifier to identify said electronic document;
program instructions, stored on at least one of the one or more storage devices, receive said delivery instruction for said electronic document; and
program instructions, stored on at least one of the one or more storage devices, to, responsive to receiving said delivery instruction, execute said delivery instruction
wherein said delivery instruction is one or more of: emailing said electronic document to an email address, saving said document to a storage resource in non-volatile memory, creating a hyperlink to said location on a web site.

16. The computer program product of claim 15, further comprising:
program instructions, stored on at least one of the one or more storage devices, to establish a communication session with said component, to establish a communication session with said component
wherein said communication session is supported using at least one of: HTTP cookies, dynamic URLs.

17. The computer program product of claim 15, said location is represented by a URL.

18. The computer program product of claim 15, wherein said identifier is represented by a URL.

19. The computer program product of claim 15, wherein said decodable indicia is provided by at least one of: a 1D bar code, a 2D bar code, and one or more OCR symbols.

20. The computer program product of claim 15, wherein said component comprises at least one of: an encoded information reading (EIR) terminal, an optical scanner, a camera.

21. The computer program product of claim 15, wherein said decoded message additionally comprises said delivery instruction.

22. A computer system for locating an electronic document, the computer system comprising:
one or more processors, one or more computer-readable memories and one or more computer-readable, tangible storage devices;
program instructions, stored on at least one of the one or more storage devices for execution by at least one of the one or more processors via at least one of the one or more memories, to an encoding request
wherein said encoding request comprises an identifier for an electronic document, the location of said electronic document;
program instructions, stored on at least one of the one or more storage devices for execution by at least one of the one or more processors via at least one of the one or more memories, to, responsive to receiving said encoding request, generate an image of decodable indicia
wherein said decodable indicia is provided by at least one of: a 1D bar code, a 2D bar code, and one or more OCR symbols and
wherein said decodable indicia comprises said identifier for an electronic document;
program instructions, stored on at least one of the one or more storage devices for execution by at least one of the one or more processors via at least one of the one or more memories, to, responsive to receiving said encoding request, retain said location on a storage resource in non-volatile memory;

23. The computer system of 22, further comprising:
program instructions, stored on at least one of the one or more storage devices for execution by at least one of the one or more processors via at least one of the one or more memories, to receive a decoding request from a component
wherein said decoding request comprises said image of decodable indicia and
wherein said component is provided by a component configured to output said image of decodable indicia
wherein said component comprises at least one of: an encoded information reading (EIR) terminal, an optical scanner, a camera;
program instructions, stored on at least one of the one or more storage devices for execution by at least one of the one or more processors via at least one of the one or more memories, to, responsive to receiving said image of decodable indicia from said component, locate said decodable indicia within said image;
program instructions, stored on at least one of the one or more storage devices for execution by at least one of the one or more processors via at least one of the one or more memories, to, responsive to locating said decodable indicia within said image, decode said decodable indicia into a decoded message
wherein said decoded message comprises: said identifier for said electronic document;
program instructions, stored on at least one of the one or more storage devices for execution by at least one of the one or more processors via at least one of the one or more memories, to, responsive to decoding said image of decodable indicia, retrieve said location from said storage resource;
program instructions, stored on at least one of the one or more storage devices for execution by at least one of the one or more processors via at least one of the one or more memories, to receive a delivery instruction for said electronic document; and
program instructions, stored on at least one of the one or more storage devices for execution by at least one of the one or more processors via at least one of the one or more memories, to, responsive to receiving said delivery instruction, execute said delivery instruction
wherein said delivery instruction is one or more of: emailing said electronic document to an email address, saving said document to a storage resource in non-volatile memory, creating a hyperlink to said location on a web site.
